(19) United States
(12) Patent Application Publication
(10) Pub. No.: US 2021/0170775 A1
(43) Pub. Date: Jun. 10, 2021

(54) SINGLE COLOR BLEND FLUORESCENT EFFECT

(71) Applicant: Xerox Corporation, Norwalk, CT (US)

(72) Inventor: Edward N. Chapman, Rochester, NY (US)

(21) Appl. No.: 16/706,772

(22) Filed: Dec. 8, 2019

(51) Int. Cl. B41M 3/14; G01J 3/46; G01J 3/10; B42D 25/387

(52) U.S. Cl. CPC B41M 3/148; G01J 3/463; B42D 25/387; B41M 3/144; G01J 3/10

(57) ABSTRACT

A method and system for reducing the appearance of a security feature viewed under UV (Ultra Violet) illumination can include selecting a colorant, wherein the colorant comprises a first UV spectral reflectance property, selecting a matching colored media, which matches a color of the colorant and which comprises a second UV spectral reflectance property that is different from the first UV spectral reflectance property, and adjusting the color of the colorant and a color of the matching color media to match one another and produce an adjusted colorant that facilitates a reduction in a visibility of the security feature based on the adjusted colorant.

### TECHNICAL FIELD

Embodiments are related to printing devices and techniques. Embodiments further relate to colorants such as ink and toner used in printing devices and techniques. Embodiments further relate to techniques for reducing the foreground or the background of a security feature such as a watermark when viewed under UV (Ultra Violet) illumination.

### BACKGROUND

In conventional printing processes, requiring security measures, a pattern color space having specialty imaging characteristics has been utilized to provide the security measures and prevent counterfeiting of printed materials. In addition, in conventional printing processes, a pattern color space has been utilized, in part on variable data, such as printing logos, serial numbers, seat locations, or other types of unique identifying information on printed materials.

In security applications, it may be desirable to add information to a document that prevents or hinders alterations and counterfeiting. These security elements may conflict with the overall aesthetics of the document. Specialty imaging has been used, conventionally, in printed materials to provide fraud protection and anti-counterfeiting measures. Some examples are in prescriptions, contracts, documents, coupons, and tickets. Typically, several specialty imaging techniques can be used at various positions in a document.

Thus, in the area of security printing, documents may be protected from copying, forging and counterfeiting using multiple techniques. Specialty Imaging is one such method of security printing, which uses standard materials such as papers inks and toners. Typically security-printing companies in the marketplace may require special (and expensive) materials. An example document is a prescription where a pharmacist would like to be able to possess a high level of confidence that a document is genuine.

Conventional printing processes can result in the creation of fluorescent effects for media under UV illumination without special toners or colors. Such effects may be composed of blocks of basic colors such as CMYK and RGB. The effect is hidden without the UV illumination, but it takes up room (or real estate) on the document.

FIG. 1 illustrates an image 10 of a prior art concert ticket 12 with fluorescent mark text 13 that can be illuminated through the use of a UV (Ultra Violet) light 15. The top part 17 of FIG. 1 shows the ticket 12 under UV illumination and the bottom part 19 shows the same ticket 12 under office lighting. The text 13 is contained with a text box 21. In this example, the text 13 shown in the top part 19 of FIG. 1 is fluorescing, and the textbox does not. The inverse also works where the textbox 21 fluoresces, and the text does not. The somewhat colored stripe of the textbox 21 detracts from the concert ticket design by using real estate in the picture. This also can detract from the overall aesthetics of the ticket.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide a method and system for reducing the appearance or visibility of a security feature viewed under UV illumination.

It is another aspect of the disclosed embodiments to provide a method and system for reducing the visibility of security features using toner/ink by using visually matched media but with a different Ultra Violet (UV) spectral reflectance of the toner/ink when as compared to the media, thus rendering the security features “invisible” under normal viewing conditions, but still visible under UV light.

The aforementioned aspects and other objectives and advantages can now be achieved as described herein. In an embodiment, a method for reducing the appearance of a security feature viewed under UV (Ultra Violet) illumination, can include: selecting a colorant, wherein the colorant comprises a first UV spectral reflectance property; selecting a matching colored media, which matches a color of the colorant and which comprises a second UV spectral reflectance property that is different from the first UV spectral reflectance property; and adjusting the color of the colorant and a color of the matching color media to match one another and produce an adjusted colorant that facilitates a reduction in a visibility of a security feature based on the adjusted colorant.

In an embodiment of the method, the colorant can comprise at least one of: a color ink or a toner blend.

An embodiment of the method can further involve rendering the security feature with the adjusted colorant.

An embodiment of the method can further involve verifying that the security feature is almost invisible under an office illumination.

An embodiment of the method can further involve verifying that the security feature is visible under an UV illumination.

An embodiment of the method can further involve rendering the security feature with the adjusted colorant, and verifying that the security feature is almost invisible under office illumination and visible under UV illumination.

In an embodiment of the method, the security feature can comprise a watermark.

In an embodiment, a system for reducing the appearance of a security feature viewed under UV (Ultra Violet) illumination, can include at least one processor and a memory, the memory storing instructions to cause the at least one processor to perform: selecting a colorant, wherein the colorant comprises a first UV spectral reflectance property; selecting a matching colored media, which matches a color of the colorant and which comprises a second UV spectral reflectance property that is different from the first UV spectral reflectance property; and adjusting the color of the colorant and a color of the matching color media to match one another and produce an adjusted colorant that facilitates a reduction in a visibility of a security feature based on the adjusted colorant.

In an embodiment of the system, the colorant can comprise at least one of: a color ink or a toner blend.

In an embodiment of the system, the instructions can further comprise instructions for performing: rendering the security feature with the adjusted colorant.

In an embodiment of the system, the instructions can further comprise instructions for performing: verifying that the security feature is almost invisible under an office illumination.

In an embodiment of the system, the instructions can further comprise instructions for performing: verifying that the security feature is visible under an UV illumination.

In an embodiment of the system, the instructions can further comprise instructions for performing: rendering the security feature with the adjusted colorant; and verifying that the security feature is almost invisible under office illumination and visible under UV illumination.

In an embodiment of the system the security feature can comprise a watermark.

In an embodiment, a security feature can comprise: a colorant selected comprising a first UV spectral reflectance property; a matching colored media selected, which matches a color of the colorant and which comprises a second UV spectral reflectance property that is different from the first UV spectral reflectance property; and wherein the color of the colorant and a color of the match color media are adjusted to match one another and produce an adjusted colorant that facilitates a reduction in a visibility of the security feature based on the adjusted colorant.

In an embodiment of the security feature, the colorant can comprise at least one of: a color ink or a toner blend.

In an embodiment, the security feature can be rendered with the adjusted colorant.

In an embodiment, the security feature can be verified as almost invisible under an office illumination.

In an embodiment, the security feature can be verified as visible under an UV illumination.

In an embodiment, the security feature can be rendered with the adjusted colorant, and the security can be verified as almost invisible under office illumination and as visible under UV illumination.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates an image of an example concert ticket and fluorescent mark text

FIG. 2 illustrates an image of a watermark on white media, in accordance with an embodiment;

FIG. 3 illustrates an image of a toner blend on media, in accordance with an embodiment;

FIG. 4 illustrates an image with a watermark color about equal to the media color with office illumination, in accordance with an embodiment;

FIG. 5 illustrates an image of a watermark under UV illumination, in accordance with an embodiment;

FIG. 6 illustrates a flow chart of operations depicting logical operational steps of a method for reducing the appearance of a security feature viewed under UV (Ultra Violet) illumination, in accordance with an embodiment;

FIG. 7 illustrates a block diagram of a printing system suitable for implementing one or more of the disclosed embodiments; and

FIG. 8 illustrates a block diagram of a digital front end controller useful for implementing one or more of the disclosed embodiments.

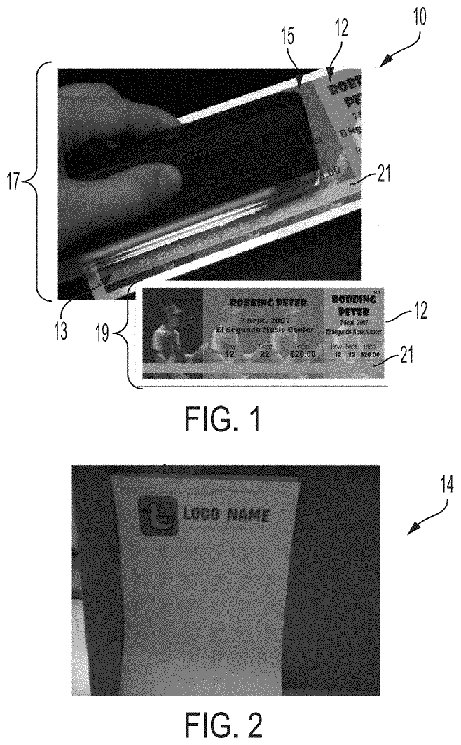

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The term “data” refers herein to physical signals that indicate or include information. An “image,” as a pattern of physical light or a collection of data representing the physical light, may include characters, words, and text as well as other features such as graphics.

A “digital image” is by extension an image represented by a collection of digital data. An image may be divided into “segments,” each of which is itself an image. A segment of an image may be of any size up to and including the whole image.

The term “image object” or “object” as used herein is believed to be considered in the art generally equivalent to the term “segment” and will be employed herein interchangeably.

In a digital image composed of data representing physical light, each element of data may be called a “pixel,” which is common usage in the art and refers to a picture element. Each pixel has a location and value. Each pixel value is a bit in a “binary form” of an image, a gray scale value in a “gray scale form” of an image, or a set of color space coordinates in a “color coordinate form” of an image, the binary form, gray scale form, and color coordinate form each being a two-dimensional array defining an image.

An operation can perform “image processing” when it operates on an item of data that relates to part of an image.

“Contrast” is used to denote the visual difference between items, data points, and the like. It can be measured as a color difference or as a luminance difference or both.

A digital color printing system is an apparatus arrangement suited to accepting image data and rendering that image data upon a substrate.

The “RGB color model” is an additive color model in which red, green, and blue can be added together in various ways to reproduce a broad array of colors. The name of the model comes from the initials of the three additive primary colors, red, green, and blue.

A primary purpose of the RGB color model is for the sensing, representation, and display of images in electronic systems. RGB is a device-dependent color model: different devices detect or reproduce a given RGB value differently, since the color elements and their response to the individual R, G, and B levels vary from manufacturer to manufacturer, or even in the same device over time. Thus, an RGB value does not define the same color across devices without some kind of color management.

The “CMYK color model” is a subtractive color model, which can be used in color printing, and can also be used to describe the printing process itself. CMYK refers to the four inks used in some color printing: cyan, magenta, yellow, and black.

“Colorant” can refer to one of the fundamental subtractive C, M, Y, K, primaries, which may be realized in formulation as, liquid ink, solid ink, dye, or electrostatographic toner. A “colorant mixture” is a particular combination of C, M, Y, K colorants. The term “colorant” as utilized herein can thus relate to colorants such an ink or a toner, including but not limited to a color ink and a toner blend.

A “security feature” can relate to an authenticating mark on media for verifying or authorizing the media or for demonstrating the authenticity of the media. An example of a security feature is a watermark.

A “watermark” can relate to identifying an image or a pattern in media (e.g. paper) that appears as various shades of lightness/darkness when viewed by transmitted light (or when viewed by reflected light, atop a dark background), caused by thickness or density variations in the paper. Watermarks have been be used on ticket, postage stamps, currency, and other government documents to discourage counterfeiting. Watermarks vary greatly in their visibility; while some may be obvious on casual inspection, others may require some study to pick out. A watermark is very useful in the examination of paper because it can be used for dating, identifying sizes, mill trademarks and locations, and determining the quality of a sheet of paper. The term “watermark” as utilized herein cal also relate to digital practices that share similarities with physical watermarks. For example, overprint on computer-printed output may be used to identify output from an unlicensed trial version of a computer program. In another example, identifying codes can be encoded as a digital watermark for a music file, a video file, an image file or another type of digital file.

An “infrared mark” is a type of watermark embedded in the image that has the property of being relatively indecipherable under normal light, and yet decipherable under infrared illumination by appropriate infrared sensing devices, such as infrared cameras.

“Metameric” rendering/printing is the ability to use multiple colorant combinations to render a single visual color, as can be achieved when printing with more than three colorants.

The disclosed embodiments can be utilized to reduce the appearance of a security feature viewed under UV (Ultra Violet) illumination. That is, the disclosed approach seeks to reduce the visibility of security features using a colorant (e.g., toner/ink) by using visually matched media, but with a different Ultra Violet (UV) spectral reflectance of the colorant when compared to the media, thereby rendering the security features “invisible” under normal viewing conditions (e.g., office illumination) but still visible under UV light. This approach can be implemented according to the following steps:
1) Select a color ink or toner blend with a UV spectral reflectance property;
2) Select a matching colored media with a UV spectral reflectance property different than step 1;
3) Adjust either or both or the colors from steps 1 and 2 to match;
4) Print a watermark with the adjusted ink and/or media and verify the watermark is almost invisible under office illumination; and
5) Verify the watermark is visible under UV illumination.

FIG. 2 illustrates an image 14 of a security feature in the form of a duck watermark disposed on white media, in accordance with an embodiment. For this example, a specific CMYK toner blend can be used. Any toner blend, however, can work if a matching media color within the printer's gamut can be found. Image 14 shown in FIG. 2 demonstrates that the duck watermark is easily visible on white media. FIG. 2 thus demonstrates Step 1 above.

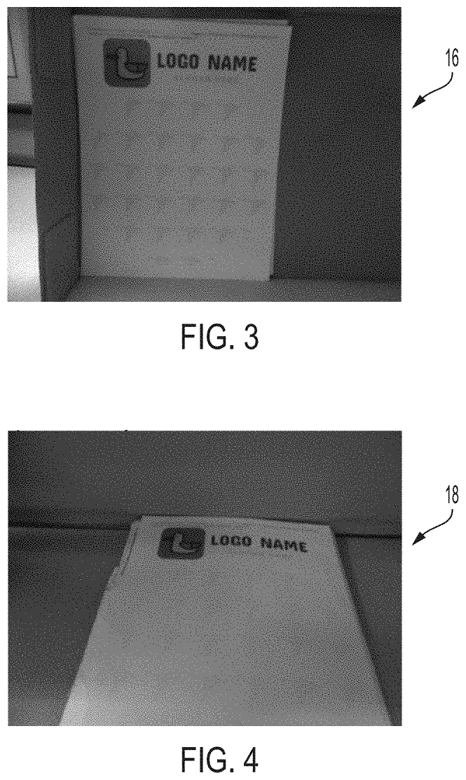

FIG. 3 illustrates an image 16 of a toner blend on media, in accordance with an embodiment. FIG. 3 demonstrates Step 2 above including selecting a hopefully matching media. The image 16 shown in FIG. 3 shows that the toner blend on selected media can be still easily seen and hence, the need for the next step of color adjustments.

FIG. 4 illustrates an image 18 with a watermark color about equal to the media color with office illumination, in accordance with an embodiment. FIG. 4 demonstrates Step 3 and Step 4 above. That is, there are different ways to adjust the color such as the media may have an ICC profile for the target printer. Calibration patches may be printed and read in to determine the color output on a media. A tool such as Xerox's CTK (color tool kit) can be used to calculate the color calibration. This may be needed on account that the media can change the appearance of the selected toner. In the example shown in FIG. 4, media affects the toner blend more than white media. The adjustment here may need to ensure that the adjusted selected toner blend on the adjusted selected media appears to be about the same color. The media can be printed to verify that that the color of the media and the watermarks are about the same.

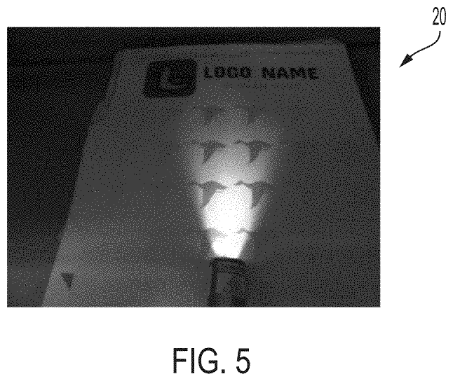

FIG. 5 illustrates an image 20 of the security feature (i.e., watermark) under UV illumination, in accordance with an embodiment. FIG. 5 demonstrates Step 5 above, that is, verifying that the fluorescent effect appears under UV illumination.

Thus, the disclosed embodiment relate to various methods and systems for reducing the foreground or the background of a security feature such as a watermark when viewed under UV (Ultra Violet) illumination (note that the non-printed may be considered as a part of the watermark). The converse may also work where the previously discussed duck watermark is not printed, but the background is, and hence the duck fluoresces.

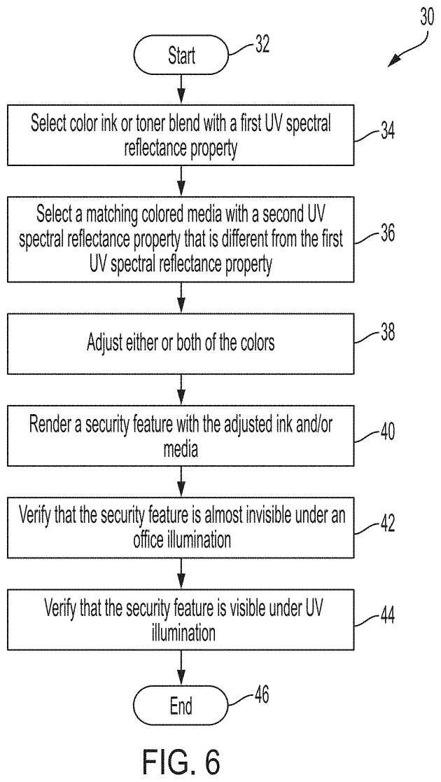

FIG. 6 illustrates a flow chart of operations depicting logical operational steps of a method 30 for reducing the appearance of a security feature viewed under UV (Ultra Violet) illumination, in accordance with an embodiment. As shown at block 32, the process can begin. As indicated at block 34, a step or operation can be implemented to select a colorant such as a color ink or toner blend with a UV spectral reflectance property. Thereafter, as shown at block 36, a step or operation can be implemented to select a matching colored media with a UV spectral reflectance property different from that described above with respect to block 34. Next, as indicated at block 38, a step or operation can be implemented to adjusted either or both or the colors with respect to block 34 and block 36 above to match.

Next, as illustrated at block 40, a step or operation can be implemented to render a security feature with the adjusted colorant (i.e., the adjusted ink) and/or media and verify that the security feature is almost “invisible” under office illumination. Thereafter, a step or operation can be implemented to verify that the watermark is visible under UV illumination. The process can then terminate, as indicated at block 46.

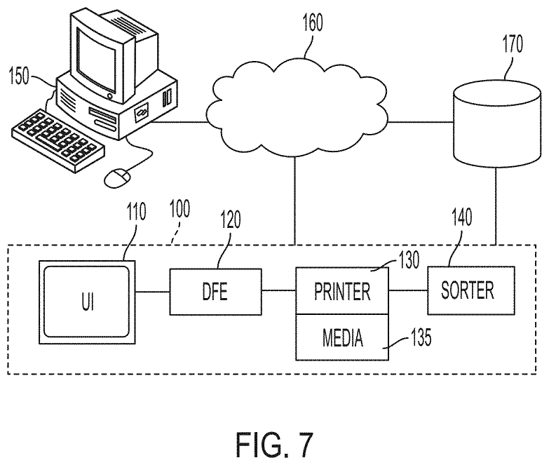

With reference to FIG. 7, a printing system (or image rendering system) 100 suitable for implementing various aspects of the exemplary embodiments described herein is illustrated.

The word “printer” and the term “printing system” as used herein encompass any apparatus and/or system; such as a digital copier, xerographic and reprographic printing systems, bookmaking machine, facsimile machine, multi-function machine, ink-jet machine, continuous feed, sheet-fed printing device, etc.; which may contain a print controller and a print engine and which may perform a print outputting function for any purpose.

The printing system 100 can include a user interface 110, a digital front end (DFE) controller 120, and at least one print engine 130. The print engine 130 has access to print media 135 of various sizes and cost for a print job. The printing system 100 can comprise a color printer having multiple color marking materials.

A “print job” or “document” is normally a set of related sheets, usually one or more collated copy sets copied from a set of original print job sheets or electronic document page images, from a particular user, or otherwise related. For submission of a regular print job (or customer job), digital data is generally sent to the printing system 100.

A sorter 140 can operate after a job is printed by the print engine 130 to manage arrangement of the hard copy output, including cutting functions. A user can access and operate the printing system 100 using the user interface 110 or via a data-processing system such as a workstation 150. The workstation 150 can communicate bidirectionally with the printing system 100 via a communications network 160.

A user profile, a work product for printing, a media library, and various print job parameters can be stored in a database or memory 170 accessible by the workstation 150 or the printing system 100 via the network 160, or such data can be directly accessed via the printing system 100. One or more color sensors (not shown) may be embedded in the printer paper path, as known in the art.

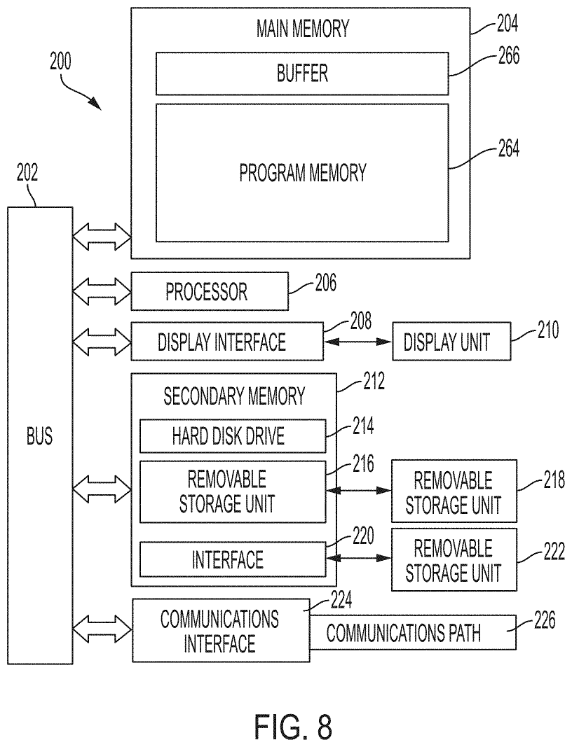

With respect to FIG. 8, an exemplary DFE controller 200 is shown in greater detail. The digital front end 200 can include one or more processors, such as processor 206 capable of executing machine executable program instructions. The processor 206 can function as a DFE processor.

In the embodiment shown, the processor 206 can be in communication with a bus 202 (e.g., a backplane interface bus, cross-over bar, or data network). The digital front end 200 can also include a main memory 204 that is used to store machine readable instructions. The main memory 204 is also capable of storing data. The main memory 204 may alternatively include random access memory (RAM) to support reprogramming and flexible data storage. A buffer 266 can be used to temporarily store data for access by the processor 206.

Program memory 264 can include, for example, executable programs that implement the embodiments of the methods described herein. The program memory 264 can store at least a subset of the data contained in the buffer. The digital front end 200 can include a display interface 208 that forwards data from communication bus 202 (or from a frame buffer not shown) to a display 210. The digital front end 200 can also include a secondary memory 212 includes, for example, a hard disk drive 214 and/or a removable storage drive 216, which reads and writes to removable storage 218, such as a floppy disk, magnetic tape, optical disk, etc., that stores computer software and/or data.

The secondary memory 212 alternatively may include other similar mechanisms for allowing computer programs or other instructions to be loaded into the computer system. Such mechanisms can include, for example, a removable storage unit 222 adapted to exchange data through interface 220. Examples of such mechanisms include a program cartridge and cartridge interface (such as that found in video game devices), a removable memory chip (such as an EPROM, or PROM) and associated socket, and other removable units and interfaces, which allow software and data to be transferred.

The digital front end 200 can include a communications interface 224, which acts as both an input and an output to allow software and data to be transferred between the digital front end 200 and external devices. Examples of a communications interface include a modem, a network interface (such as an Ethernet card), a communications port, a PCMCIA slot and card, etc.

Computer programs (also called computer control logic) and including one or more modules may be stored in the main memory 204 and/or the secondary memory 212. Computer programs or modules may also be received via a communications interface 224. Such computer programs or modules, when executed, enable the computer system to perform the features and capabilities provided herein. Software and data transferred via the communications interface can be in the form of signals which may be, for example, electronic, electromagnetic, optical, or other signals capable of being received by a communications interface.

These signals can be provided to a communications interface via a communications path (i.e., channel), which carries signals and may be implemented using wire, cable, and fiber optic, phone line, cellular link, RF, or other communications channels.

Part of the data generally stored in secondary memory 212 for access during an DFE operation may be a set of translation tables that can convert an incoming color signal into a physical machine signal.

This color signal can be expressed either as a colorimetric value; usually three components as L*a*b*, RGB, XYZ, etc.; into physical exposure signals for the four toners cyan, magenta, yellow and black. These tables can be created outside of the DFE and downloaded, but may be optionally created inside the DFE in a so-called characterization step.

Several aspects of data-processing systems will now be presented with reference to various systems and methods. These systems and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A mobile “app” is an example of such software.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer.

The disclosed example embodiments are described at least in part herein with reference to flowchart illustrations and/or block diagrams and/or schematic diagrams of methods, systems, and computer program products and data structures according to embodiments of the invention. It will be understood that each block of the illustrations, and combinations of blocks, can be implemented by computer program instructions. These computer program instructions may be provided to a processor of, for example, a general-purpose computer, special-purpose computer, or other programmable data processing apparatus to produce a machine, such that the instructions, which execute via the processor of the computer or other programmable data processing apparatus, create means for implementing the functions/acts specified in the block or blocks.

To be clear, the disclosed embodiments can be implemented in the context of, for example a special-purpose computer or a general-purpose computer, or other programmable data processing apparatus or system. For example, in some example embodiments, a data processing apparatus or system can be implemented as a combination of a special-purpose computer and a general-purpose computer. The computer program product may include a computer readable storage medium (or media) having computer readable program instructions thereon for causing a processor to carry out aspects of the embodiments.

The aforementioned computer program instructions may also be stored in a computer-readable memory that can direct a computer or other programmable data processing apparatus to function in a particular manner, such that the instructions (e.g., steps/operations) stored in the computer-readable memory produce an article of manufacture including instruction means which implement the function/act specified in the various block or blocks, flowcharts, and other architecture illustrated and described herein.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

The flow charts and block diagrams in the figures illustrate the architecture, functionality, and operation of possible implementations of systems, methods, and computer program products according to various embodiments (e.g., preferred or alternative embodiments). In this regard, each block in the flow chart or block diagrams depicted and described herein can represent a module, segment, or portion of instructions, which can comprise one or more executable instructions for implementing the specified logical function(s).

In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The functionalities described herein may be implemented entirely and non-abstractly as physical hardware, entirely as physical non-abstract software (including firmware, resident software, micro-code, etc.) or combining non-abstract software and hardware implementations that may all generally be referred to herein as a “circuit,” “module,” “engine”, “component,” “block”, “database”, “agent” or “system.” Furthermore, aspects of the present disclosure may take the form of a computer program product embodied in one or more non-ephemeral computer readable media having computer readable and/or executable program code embodied thereon.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” (also referred to as an “engine”) may constitute a software application, but can also be implemented as both software and hardware (i.e., a combination of software and hardware).

Generally, program modules include, but are not limited to, routines, subroutines, software applications, programs, objects, components, data structures, etc., that perform particular tasks or implement particular data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

In some example embodiments, the term “module” can also refer to a modular hardware component or a component that is a combination of hardware and software. It should be appreciated that implementation and processing of such modules according to the approach described herein can lead to improvements in processing speed and in energy savings and efficiencies in a data-processing system such as, for example, the printing system 100 shown in FIG. 7 and/or the DFE controller 200 shown in FIG. 8. A “module” can perform the various steps, operations or instructions discussed herein, such as the steps or operations shown and discussed herein with respect to the various blocks depicted in FIG. 6.

It is understood that the specific order or hierarchy of steps, operations, or instructions in the processes or methods disclosed is an illustration of exemplary approaches. For example, the various steps, operations or instructions discussed herein can be performed in a different order. Similarly, the various steps and operations of the disclosed example pseudo-code discussed herein can be varied and processed in a different order. Based upon design preferences, it is understood that the specific order or hierarchy of such steps, operation or instructions in the processes or methods discussed and illustrated herein may be rearranged. The accompanying claims, for example, present elements of the various steps, operations or instructions in a sample order, and are not meant to be limited to the specific order or hierarchy presented.

The inventors have realized a non-abstract technical solution to the technical problem to improve a computer-technology by improving efficiencies in such computer technology. The disclosed embodiments offer technical improvements to a computer-technology such as a data-processing system, and further provide for a non-abstract improvement to a computer technology via a technical solution to the technical problem(s) identified in the background section of this disclosure. Such improvements can result from implementations of the disclosed embodiments. The claimed solution may be rooted in computer technology in order to overcome a problem specifically arising in the realm of computers, computer networks and call center platforms.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

1. A method for reducing the appearance of a security feature viewed under UV (Ultra Violet) illumination, comprising:
selecting a colorant, wherein the colorant comprises a first UV spectral reflectance property;
selecting a colored media, which comprises a second UV spectral reflectance property that is different from the first UV spectral reflectance property;
calibrating the color of the colorant and a color of the colored media to match one another; and
producing an adjusted colorant based on at least one of the calibrated color of the colorant and the calibrated color of the colored media, wherein the adjusted colorant facilitates a reduction in a visibility of a security feature based on the adjusted colorant.

2. The method of claim 1 wherein the colorant comprises a toner blend and wherein calibrating the color of the colorant and the color of the colored media to match one another further involves performing the calibrating with at least one calibration patch.

3. The method of claim 1 further comprising rendering the security feature with the adjusted colorant.

4. The method of claim 1 further comprising verifying that the security feature is almost invisible under an office illumination.

5. The method of claim 1 further comprising verifying that the security feature is visible under an UV illumination.

6. The method of claim 1 further comprising:
rendering the security feature with the adjusted colorant; and
verifying that the security feature is almost invisible under office illumination and visible under UV illumination.

7. The method of claim 1 wherein security feature comprises a watermark.

8. The system for reducing the appearance of a security feature viewed under UV (Ultra Violet) illumination, comprising:
at least one processor and a memory, the memory storing instructions to cause the at least one processor to perform:
selecting a colorant, wherein the colorant comprises a first UV spectral reflectance property;
selecting a colored media, which comprises a second UV spectral reflectance property that is different from the first UV spectral reflectance property;
calibrating the color of the colorant and a color of the colored media to match one another; and
producing an adjusted colorant based on at least one of the calibrated color of the colorant and the calibrated color of the colored media, wherein the adjusted colorant facilitates a reduction in a visibility of a security feature based on the adjusted colorant.

9. The system of claim 8 wherein the colorant comprises a toner blend.

10. The system of claim 8 wherein the instructions further comprise instructions for performing: rendering the security feature with the adjusted colorant.

11. The system of claim 8 wherein the instructions further comprise instructions for performing: verifying that the security feature is almost invisible under an office illumination.

12. The system of claim 8 wherein the instructions further comprise instructions for performing: verifying that the security feature is visible under an UV illumination.

13. The system of claim 8 wherein the instructions further comprise instructions for performing:
rendering the security feature with the adjusted colorant; and
verifying that the security feature is almost invisible under office illumination and visible under UV illumination.

14. The system of claim 8 wherein security feature comprises a watermark.

15. A security feature, comprising:
a colorant selected comprising a first UV spectral reflectance property;
a colored media selected, which comprises a second UV spectral reflectance property that is different from the first UV spectral reflectance property; and
wherein the color of the colorant and a color of the colored media are calibrated to match one another and produce an adjusted colorant based on at least one of the calibrated color of the colorant and the calibrated color of the colored media, wherein the adjusted colorant facilitates a reduction in a visibility of the security feature based on the adjusted colorant.

16. The security feature of claim 15 wherein the colorant comprises a toner blend.

17. The security feature of claim 15 wherein the security feature is rendered with the adjusted colorant.

18. The security feature of claim 15 wherein the security feature if verified as almost invisible under an office illumination.

19. The security feature of claim 15 wherein the security feature is verified as visible under an UV illumination.

20. The security feature of claim 15 wherein the security feature is rendered with the adjusted colorant, and the security is verified as almost invisible under office illumination and as visible under UV illumination.
